(19) United States
(12) Patent Application Publication
(10) Pub. No.: US 2013/0292540 A1
(43) Pub. Date: Nov. 7, 2013

(54) SOAKER HOSE SECURING PIN

(71) Applicant: EDWARD NYE REHKOPF, MOUNT ULLA, NC (US)

(72) Inventor: EDWARD NYE REHKOPF, MOUNT ULLA, NC (US)

(21) Appl. No.: 13/873,290

(22) Filed: Apr. 30, 2013

Related U.S. Application Data
(60) Provisional application No. 61/642,478, filed on May 4, 2012.

(51) Int. Cl. F16M 13/00

(52) U.S. Cl. CPC F16M 13/00
USPC 248/545

(57) ABSTRACT

Inexpensive and easily attachable wire pin that secures the path of garden soaker hoses so that water is delivered to the desired locations.

### CROSS REFERENCE TO RELATED APPLICATION

Provisional Patent Application No. 61/642,478, filed 2012 May 4.

### DESCRIPTION

The invention provides wire pins for securing soaker hoses to the around in multiple locations along its path, providing an easily movable placement along any point of the soaker hose, while making allowances for the inherent twists or kinks of the soaker hose.

The soaker hose securing pin is of a form that is easily inserted into the ground and easily attached at any point to the soaker hose while providing sufficient strength and rigidity to hold the soaker hose in place, thereby directing the Water where desired by the gardener. As many pins as necessary can be employed to shape the exact path of the soaker hose as desired.

Depending upon the depth to which the pin or pins are pressed into the soil, the invention can hold the soaker hose above the soil, lessening the chance that the soaker hose boles may become plugged with soil and debris.

Because of the malleability of the wire, gardeners can easily enlarge or tighten the radius of the holding mechanism and/or clip off the lower end of the wire to shorten the height of the invention should highly compacted soils make it difficult to penetrate the securing pin to the desired depth (or to hold the soaker hose at the desired height above the soil surface).

The invention provides for a simpler and less costly manufacture than other designs for an item of similar purpose. See drawing.

### BACKGROUND OF THE INVENTION

The present invention is designed as a securing pin, and in particular as a wire pin for securing, soaker hoses to the ground.

A problem often encountered by gardeners when using so called “soaker hoses” (of the circular profile variety of rubber or plastic hoses having a plurality of holes therein providing dripping water along the path of the hose) is that such hoses are susceptible to twisting and turning, and thus misdirecting the water. Often the common solution is to place rocks or clods of din atop the hose to hold it in place.

Similarly, gardeners often want to easily redirect or move the path of the soaker hose toward or away from particular plants based on the amount of watering desired.

### BRIEF SUMMARY OF THE INVENTION

The present invention provides wire pins for securing soaker hoses to the ground in multiple locations along its path, providing an easily movable placement along any point of the soaker hose, while making allowances for the inherent twists or kinks of the soaker hose.

Further, a pin in accordance with the present invention is of a form that is easily inserted into the ground and easily attached at any point to the soaker hose while providing sufficient strength and rigidity to hold the soaker hose in place, thereby directing the water where desired by the gardener. As many pins as necessary can be employed to shape the exact path of the soaker hose as desired.

Further, depending upon the depth to which the pin or pins are pressed into the soil, the invention can hold the soaker hose above the soil, lessening the chance that the soaker hose holes may become plugged with soil and debris.

Further, because of the malleability of the wire, gardeners can easily enlarge or tighten the radius of the holding mechanism and/or dip off the lower end of the wire to shorten the height of the invention should highly compacted soils make it difficult to penetrate the securing in to the desired depth (or to hold the soaker hose at the desired height above the soil surface).

Further, the present invention provides tin a simpler and less costly manufacture than other designs for an item of similar purpose.

### BRIEF DESCRIPTION OF THE DRAWING

A preferred exemplary embodiment of the present invention is hereinafter described in conjunction with the appended drawing, wherein like numerals denote like elements:

FIG. 1 is a drawing in front view of a pin in accordance with the present invention.

FIG. 2 is a side view of same.

### DETAILED DESCRIPTION OF THE PREFERRED EXEMPLARY EMBODIMENT

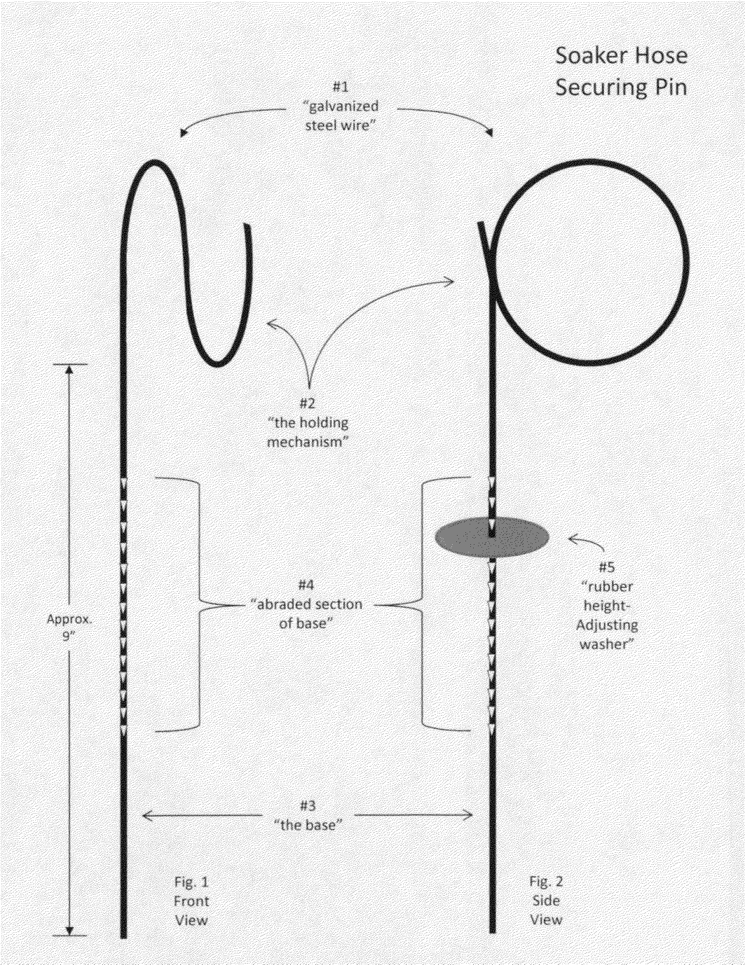

Referring now to FIGS. 1 and 2, a galvanized steel wire (#1) of approximately 10 gauge, in a length of approximately 12 inches, is shaped so that the top 3 inches (approximate) forms an offset circle of approximately 1 1/4 inches in diameter to create the holding mechanism (#2) for the soaker hose. The remaining 9 inches (approximate) of the wire creates the base (#3) which is used to penetrate the garden soil to the desired depth. Several inches of length along the base (#4) are abraded in the manufacturing process to arrest a rubber height-adjusting washer (#5) at a level appropriate to achieving the desired height of the soaker hose above the soil surface.

It will be understood that the above description of a preferred exemplary embodiment of the present invention and that the invention is not limited to the specific dimensions as described. Modifications may be made in the design and shaping of the elements without departing from the spirit of the invention as expressed in the following claim.

What is claimed is:

1. A securing pin comprising:
a section of galvanized steel wire of approximately 10 gauge of approximately 12 inches in length,
said wire shall be so shaped that the end 3 inches (at what will be the top of the pin), is curved to create a circular holding mechanism of approximately 1¼ inch in diameter, with the end of the wire offset from the plane of the base wire by approximately 1¼ inch to facilitate attachment to the soaker hose,
a section of the said wire base is abraded during manufacture and a rubber washer (with a center hole slightly less than the diameter of the securing pin wire) is slipped up the base to an abraded position that will hold the soaker hose at the desired height above the soil surface.
